(19) United States
(12) Patent Application Publication
(10) Pub. No.: US 2014/0167547 A1
(43) Pub. Date: Jun. 19, 2014

(54) ELECTRIC MACHINE WITH FRACTIONAL SLOT WINDINGS

(71) Applicant: GM GLOBAL TECHNOLOGY OPERATIONS LLC, Detroit, MI (US)

(72) Inventors: Lei Hao, Troy, MI (US); Khwaja M. Rahman, Troy, MI (US); Edward L. Kaiser, Orion, MI (US); Rolf Blissenbach, Torrance, CA (US)

(73) Assignee: GM GLOBAL TECHNOLOGY OPERATIONS LLC, Detroit, MI (US)

(21) Appl. No.: 13/715,047

(22) Filed: Dec. 14, 2012

(51) Int. Cl. H02K 1/27; H02K 1/16

(52) U.S. Cl. CPC H02K 1/27; H02K 1/165
USPC 310/156.01

(57) ABSTRACT

An electric machine includes a stator core defining a number of stator slots (Z). A rotor assembly is positioned at least partially within the stator core. The rotor assembly includes at least one permanent magnet and defines a number of poles (M). A plurality of stator windings are positioned in the number of stator slots and define a number of phases (M). The machine defines a non-integer slots per pole per phase value (X), which is expressed as a mixed fraction in the form of A.(B/C), where A, B and C are integers. Optimal configurations for the electric machine are specified that maximize torque while minimizing torque ripple, noise and manufacturing complexity. In one embodiment, the slots per pole per phase value (X) is 2½. In another embodiment, the slots per pole per phase value (X) is 3½.

### TECHNICAL FIELD

The disclosure relates generally to an electric machine and, more particularly, to optimal configurations for an interior permanent magnet machine.

### BACKGROUND

An electric machine such as an interior permanent magnet machine generally includes a rotor having a plurality of magnets of alternating polarity positioned near the outer periphery of the rotor. The rotor is rotatable within a stator assembly which generally includes a plurality of stator windings. The configuration of the stator assembly affects the torque output of the electric machine as well as the amount of undesirable torque ripple (resulting in vibration and noise) produced by the electric machine.

### SUMMARY

An electric machine includes a stator core defining a number of stator slots (Z). A rotor assembly is positioned at least partially within the stator core. The rotor assembly includes at least one permanent magnet and defines a number of poles (M). A plurality of stator windings are positioned in the number of stator slots (Z) and define a number of phases (M). Optimal configurations for the electric machine are specified that maximize torque while minimizing torque ripple, noise and manufacturing complexity.

The machine defines a non-integer slots per pole per phase value (X), which is expressed as a mixed fraction in the form of A(^{B}/_{C}), where A, B and C are integers. The number of poles (P) may be greater than or equal to 12. The optimal configuration requires that the value of C may not be equal to the number of phases (M). The greatest common divisor (GCD) of the number of stator slots (Z) and the number of poles (P) is at least 6, where the GCD is defined as the largest positive integer that divides the number of stator slots (Z) and the number of poles (P) without a remainder.

In one embodiment, the slots per pole per phase value (X) is exactly 2½.In one example, the number of phases (M) is 3, the number of poles (P) is 12 and the number of stator slots (Z) is 90. In another example, the number of phases (M) is 3, the number of poles (P) is 14 and the number of stator slots (Z) is 105. In another example, the number of phases (M) is 3, the number of poles (P) is 16 and the number of stator slots (Z) is 120. In another example, the number of phases (M) is 3, the number of poles (P) is 18 and the number of stator slots (Z) is 135.

In another embodiment, the slots per pole per phase value (X) is exactly 3½. In one example, the number of phases (M) is 3, the number of poles (P) is 12 and the number of stator slots (Z) is 126. In another example, the number of phases (M) is 3, the number of poles (P) is 14 and the number of stator slots (Z) is 147. In another example, the number of phases (M) is 3, the number of poles (P) is 16 and the number of stator slots (Z) is 168.

In another embodiment, the slots per pole per phase value (X) is exactly 3½. In one example, the number of phases (M) is 3, the number of poles (P) is 14 and the number of stator slots (Z) is 63. In another example, the number of phases (M) is 3, the number of poles (P) is 16 and the number of stator slots (Z) is 72. In another example, the number of phases (M) is 3, the number of poles (P) is 18 and the number of stator slots (Z) is 81.

The plurality of stator windings may include at least five parallel paths per phase. The lowest common multiplier (LCM) of the number of stator slots (Z) and the number of poles (P) may be at least 72. The LCM is defined as a smallest positive integer that is divisible by both the number of stator slots (Z) and the number of poles (P).

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view of an electric machine having a stator assembly;

FIG. 2 is a schematic fragmentary sectional view of the electric machine along axis 2-2 of FIG. 1, in accordance with a first embodiment;

FIG. 3 is a schematic fragmentary sectional view of the stator assembly of FIG. 1;

FIG. 4 is an enlarged view of the portion 4 of FIG. 2;

FIG. 5 is a schematic fragmentary sectional view of the electric machine along axis 2-2 of FIG. 1, in accordance with a second embodiment;

FIG. 6 is a schematic fragmentary sectional view of the electric machine along axis 2-2 of FIG. 1, in accordance with a third embodiment; and

FIG. 7 is a schematic diagram of one example of electrical connections or parallel paths per phase of stator windings in the stator assembly of FIG. 1.

### DETAILED DESCRIPTION

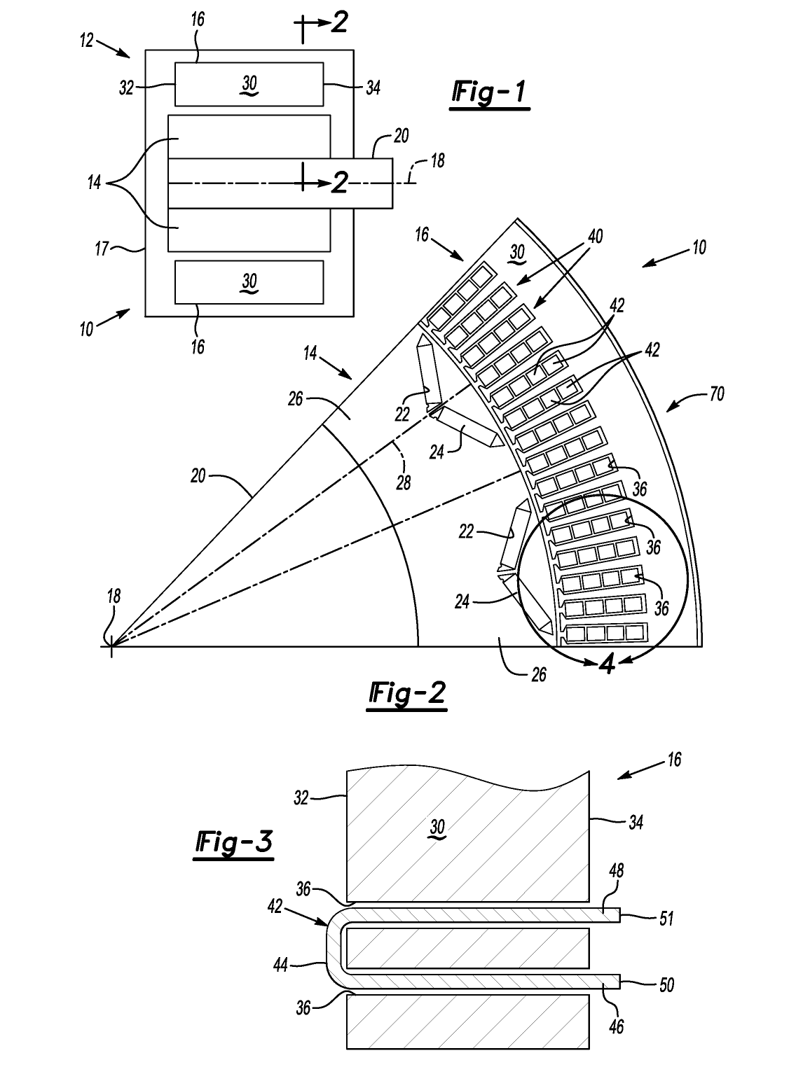

Referring to the Figures, wherein like reference numbers refer to the same or similar components throughout the several views, FIG. 1 is a schematic plan view of an electric motor/generator or electric traction machine, referred to herein as electric machine 10. The electric machine 10 may be employed in a vehicle 12. The vehicle 12 may be any passenger or commercial automobile such as a hybrid electric vehicle including a plug-in hybrid electric vehicle, an extended range electric vehicle, or other vehicles. The electric machine 10 may include any device configured to generate a electric machine torque by, for example, converting electrical energy into rotational motion. For instance, the electric machine 10 may be configured to receive electrical energy from a power source, such as a battery array (not shown). The power source may be configured to store and output electrical energy, such as direct current (DC) energy. The vehicle 12 may include an inverter (not shown) for converting the DC energy from the battery array into alternating current (AC) energy. The electric machine 10 may be configured to use the AC energy from the inverter to generate rotational motion. The electric machine 10 may be further configured to generate electrical energy when provided with a torque, such as the engine torque.

FIG. 2 is a schematic fragmentary sectional view of a portion of the electric machine 10. Referring to FIGS. 1-2, the electric machine 10 includes a rotor assembly 14 and a stator assembly 16. The machine 10 may include a housing 17 for supporting the rotor assembly 14 and stator assembly 16. Referring to FIGS. 1-2, the rotor assembly 14 is rotatable relative to and within the stator assembly 16 about a longitudinal axis 18 (extending out of the page in FIG. 2). The rotor assembly 14 may be annularly-shaped and positioned around a shaft 20, shown in FIGS. 1-2.

Referring to FIG. 2, the rotor assembly 14 includes a plurality of rotor slots 22 that extend into the body of the rotor assembly 14 and define a three-dimensional volume having any suitable shape. The rotor assembly 14 may be formed with any number of rotor slots 22. One or more permanent magnets 24 may be positioned within the rotor slots 22.

The rotor assembly 14 includes a plurality of poles. FIG. 2 illustrates a pole pair or two poles, both of which are generally indicated by reference numeral 26. The total number of poles 26 in the rotor assembly 14 is referred to herein or defined as “P.” Each pole 26 is defined by a respective pole axis, one of which is generally indicated by reference numeral 28. The rotor slots 22 may be configured to be symmetric relative to the respective pole axis 28. Each pole 26 is formed at least in part by the permanent magnets 24 in the rotor slots 22.

Referring to FIG. 1, the stator assembly 16 includes a stator core 30 extending along the longitudinal axis 18, between a first axial end 32 and a second axial end 34. FIG. 3 is a schematic fragmentary sectional view of the stator assembly 16. Referring to FIGS. 2-3, the stator core 30 defines a plurality of stator slots 36. The number of stator slots 36 in the stator assembly 16 is referred to herein or defined as “Z.” Referring to FIG. 2, the stator slots 36 extend lengthwise along the longitudinal axis 18 (extending out of the page), and are angularly spaced about the longitudinal axis 18. Referring to FIG. 2, the stator slots 36 may be evenly spaced from each other radially about the longitudinal axis 18.

Referring to FIG. 2, a plurality of stator windings 40 are positioned in each of the stator slots 36 in order to define one or more winding sets. In the embodiment shown, the stator windings 40 comprise segmented bar conductors 42 positioned in the stator slots 36. Referring to FIG. 3, the stator core 30 and one bar conductor 42 is shown schematically to illustrate the relative positioning of the bar conductor 42 with respect to the stator core 30. FIG. 3 only shows one bar conductor 42 for clarity. Each bar conductor 42 spans a pre-determined number of stator slots 36. The span of the bar conductors 42 is defined as the angular distance between stator slots 36 through which a single bar conductor 42 is positioned.

Each bar conductor 42 includes a crown portion 44, i.e., a “U” shaped end turn, and two leg portions, i.e., a first leg portion 46 and a second leg portion 48. The first and second leg portions 46, 48 extend from the crown portion 44 to a first bar end 50 and a second bar end 51, respectively. The first leg portion 46 and the second leg portion 48 of each bar conductor 42 are disposed within different stator slots 36 of the stator core 30. The U-shaped bar conductors are also referred to as “hairpin” conductors. It is understood that the bar conductor 42 shown in FIG. 3 is only schematic, and is not meant to represent the scale or specific shape of the bar conductors 42 as is known to those skilled in the art. Referring to FIG. 2, the bar conductors 42 may include a substantially rectangular cross-section. However, any other cross-sectional shape may be employed.

Referring to FIG. 3, the crown portion 44 of each of the bar conductors 42 defines a crown end of the stator core 30. The first and second bar ends 50, 51 of the bar conductors 42 extend past the second axial end 34 of the stator core 30 along the longitudinal axis 18 to define a weld end of the stator core 30. After insertion, first and second bar ends 50, 51 are bent outward to enable connections between respective bar conductors 42 by welding.

Referring to FIG. 2, the stator windings 40 define a number of phases (M). The stator windings 40 may be separated into separate winding sets, each of which defines an identical number of phases (M). In one embodiment, each winding set defines three phases, i.e., the winding set defines a “U” phase, a “V” phase and a “W” phase. In another embodiment, each winding set defines five phases, i.e., the winding set defines a “U” phase, a “V” phase, an “X” phase, a “Y” phase and a “Z” phase. However, the electric machine 10 is not limited to a three or five phase machine, and the number of phases may differ from the phases described herein.

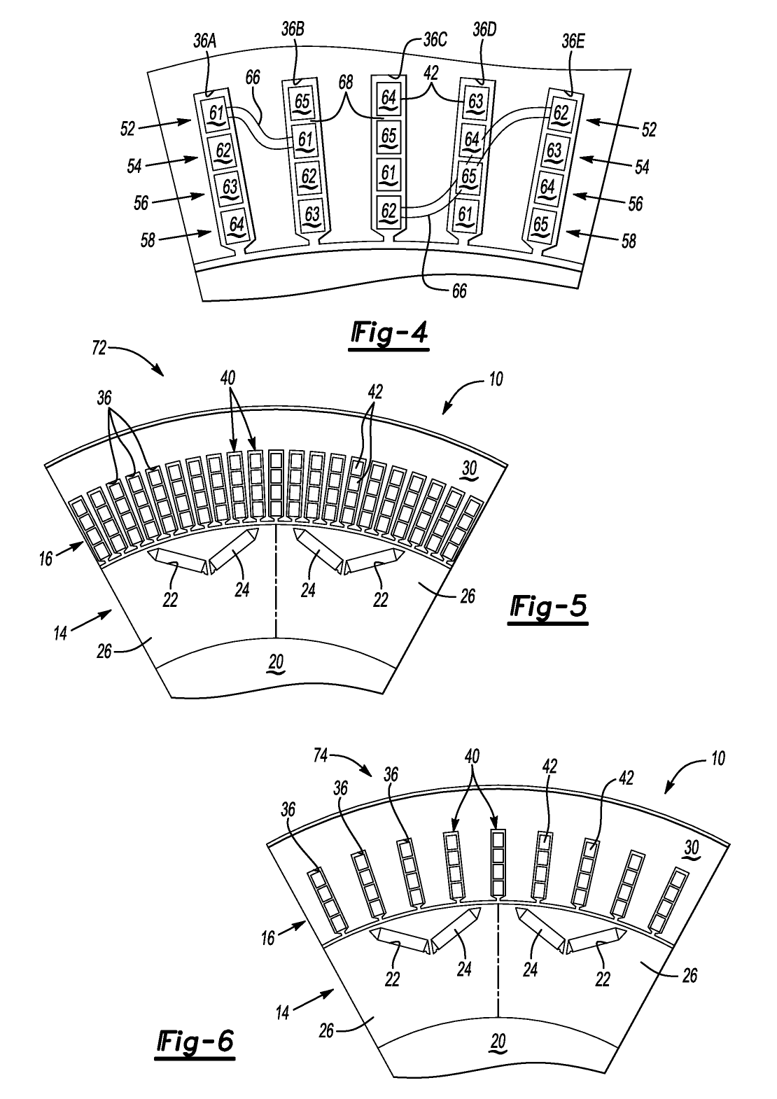

FIG. 4 is an enlarged view of portion 4 of FIG. 2 showing stator slots 36A, B, C, D and E. Each stator slot 36A-E includes a pre-determined number of leg portions (such as first and second leg portions 46, 48 shown in FIG. 3) and each leg portion is referred to as a “layer” within the stator slot 36. Referring to FIG. 4, each stator slot 36A-E of the machine 10 includes four layers of bar conductors 42 (i.e., four leg portions) carrying either the same phase current or a different phase current. Referring to FIG. 4, the layers are referenced herein as the first layer 52 (i.e., the layer closest to an inner diameter of the stator core 30), second layer 54, third layer 56 and fourth layer 58 (i.e., the layer furthest from the inner diameter of the stator core 30). However, it should be appreciated that each stator slot 36 may include a different number of layers of bar conductors 42, including but not limited to, two layers or six layers. The maximum number of winding sets is typically determined by the product of the number of stator slots per pole per phase (X) (described below) and the number of layers in the stator slot 36. Thus, if the number of stator slots per pole per phase (X) is 2½ and the number of layers is 4, the maximum number of winding sets would be 10.

Referring to FIG. 4, the stator windings 40 may include five winding sets 61, 62, 63, 64, 65. However, the stator windings 40 may include any number of winding sets as suitable for the particular application at hand. Winding set 61 is in stator slots 36A-D. Winding set 62 is in stator slots 36A-C, E. Winding set 63 is in stator slots 36A-B, D-E. Winding set 64 is in stator slots 36A, C-E. Winding set 65 is in stator slots 36B-E. Referring to FIG. 4, the stator assembly 24 may include jumpers 66 for electrically engaging the ends of at least two bar conductors 42. For clarity, only two jumpers 66 are shown. The stator assembly 24 may include insulation 68 disposed between the first through fourth layers 52, 54, 56 and 58 of the stator slot 36 to prevent electrical connection between the respective layers 52, 54, 56 and 58. The maximum number of winding sets is typically determined by the product of the number of stator slots per pole per phase (X) (described below) and the number of layers in the stator slot 36. Thus, if the number of stator slots per pole per phase (X) is 2½ and the number of layers is 4, the maximum number of winding sets would be 10.

An electric machine 10 may vary the system voltage and torque it produces by varying the number of turns in series per phase (N) in its design. For rectangular hairpin windings, N may be expressed as:

N=[P*X*W/n],

where P is the number of poles; X is the number of stator slots per pole per phase; W is the number of winding sets; and n is the number of parallel paths per phase. Typically the slots per pole per phase value (X) is an integer.

Referring to FIGS. 2 and 4, an optimal configuration 70 for the bar wound electric machine 10 is specified. The optimal configuration 70 for the electric machine 10 includes a defined parameter set that maximizes torque while minimizing torque ripple, noise and manufacturing complexity. Referring to FIGS. 2-3, the optimal configuration 70 defines a non-integer value of stator slots per pole per phase, symbolized as “X.” X is expressed as a mixed fraction in the form of A(^{B}/_{C}), where A, B and C are integers.

Referring to FIG. 2, in a first optimal configuration 70, the slots per pole per phase value (X) is set to be exactly 2½. In the first optimal configuration 70, the number of poles (P) may be greater than or equal to 12. The value of C may not be equal to the number of phases (M). In the first optimal configuration 70, the greatest common divisor (GCD) of the number of stator slots (Z) and the number of poles (P), is at least 6. The GCD is defined as the largest positive integer that divides the number of stator slots (Z) and the number of poles (p) without a remainder. The greatest common divisor (GCD) is also known as the greatest common factor, or highest common factor. Requiring a minimum GCD of 6 reduces the amount of undesired noise in the machine 10.

In the first optimal configuration 70, the lowest common multiplier (LCM) of the number of stator slots (Z) and the number of poles (P) is at least 72. The LCM is defined as the smallest positive integer that is divisible by both the number of stator slots (Z) and the number of poles (P). Requiring a minimum LCM of 72 reduces the amount of undesired clogging torque in the machine 10. As is known to those skilled in the art, clogging torque is a component of torque ripple.

In the first optimal configuration 70, since the slots per pole per phase value (X) is exactly 2½, the number of stator slots 36 found in the two poles 26 (or stator slots per pole pair) may be determined by the number of phases (M) in each winding set. For example, if the number of phases (M) is 3 in each winding set, the number of stator slots 36 found in the two poles 26 (i.e. the number of stator slots 36 per pole pair) is fifteen [number of stator slots per pole pair=2½ (slots per pole per phase)*3 phases*2 poles per pole pair]. As commonly understood, the asterisk * refers to multiplication. Thus the embodiment illustrated in FIG. 2 shows fifteen stator slots 36 for the two poles 26. The number of stator slots (Z) in each case will be 2½ (slots per pole per phase) multiplied by the number of phases (M) and the number of poles (P).

In one example, the number of phases (M) is 3 and the number of poles (P) is 12. In this case the total number of stator slots (Z) will be 90 (2½*3*12). This configuration results in the greatest common divisor (GCD) of the number of stator slots (Z=90) and the number of poles (P=12) being 6. This configuration results in the lowest common multiplier (LCM) of the number of stator slots (Z=90) and the number of poles (P=12) being 180.

In another example, the number of phases (M) is 3 and the number of poles (P) is 14. In this case the number of stator slots (Z) will be 105 (2½*3*14). This configuration results in the greatest common divisor (GCD) of the number of stator slots (Z=105) and the number of poles (P=14) being 7. This configuration results in the lowest common multiplier (LCM) of the number of stator slots (Z=105) and the number of poles (P=14) being 210.

In another example, the number of phases (M) is 3 and the number of poles (P) is 16. In this case the number of stator slots (Z) will be 120 (2½*3*16). This configuration results in the greatest common divisor (GCD) of the number of stator slots (Z=120) and the number of poles (P=16) being 8. This configuration results in the lowest common multiplier (LCM) of the number of stator slots (Z=120) and the number of poles (P=16) being 240.

In another example, the number of phases (M) is 3 and the number of poles (P) is 18. In this case the number of stator slots (Z) will be 135 (2½*3*18). This configuration results in the greatest common divisor (GCD) of the number of stator slots (Z=135) and the number of poles (P=18) being 9. This configuration results in the lowest common multiplier (LCM) of the number of stator slots (Z=135) and the number of poles (P=18) being 270.

Alternatively, the slots per pole per phase (X) may be set to be exactly 2½, with the number of phases (M) being set as 5. The number of poles (P) may be set to be 12. In this case the number of stator slots (Z) will be 150 (2½*5*12). This configuration results in the greatest common divisor (GCD) of the number of stator slots (Z=150) and the number of poles (P=12) being 6. This configuration results in the lowest common multiplier (LCM) of the number of stator slots (Z=150) and the number of poles (P=12) being 300.

Referring now to FIG. 5, a second optimal configuration 72 is shown for the electric machine 10, with like reference numbers referring to the same or similar components. The second optimal configuration 72 is similar to the first optimal configuration 70, unless otherwise described. In the second optimal configuration 72, the slots per pole per phase value (X) is set to be exactly 3½. Since the slots per pole per phase value (X) is exactly 3½, the number of stator slots 36 found in the two poles 26 (or stator slots per pole pair) may be determined by the number of phases (M) in each winding set. For example, if the number of phases (M) is 3 in each winding set, the number of stator slots 36 found in two poles 26 (i.e. stator slots 36 per pole pair) is twenty one [number of stator slots per pole pair=3½ (slots per pole per phase)*3 phase*2 poles per pole pair]. The embodiment illustrated in FIG. 5 shows twenty one stator slots 36 for the two poles 26.

Similar to the first optimal configuration 70, the value of C may not be equal to the number of phases (M) in the second optimal configuration 72 and the number of poles (P) may be greater than or equal to 12. Also similar to the first optimal configuration 70, the greatest common divisor (GCD) in the second optimal configuration 72, of the number of stator slots (Z) and the number of poles (P), is at least 6. The GCD is defined as the largest positive integer that divides the number of stator slots (Z) and the number of poles (p) without a remainder. In the second optimal configuration 72, the lowest common multiplier (LCM) of the number of stator slots (Z) and the number of poles (P) is at least 72.

In one example, the number of phases (M) is 3 and the number of poles (P) is 12. In this case the total number of stator slots (Z) will be 126 (3½*3*12). This configuration results in the greatest common divisor (GCD) of the number of stator slots (Z=126) and the number of poles (P=12) being 6. This configuration results in the lowest common multiplier (LCM) of the number of stator slots (Z=126) and the number of poles (P=12) being 252.

In another example, the number of phases (M) is 3 and the number of poles (P) is 14. In this case the number of stator slots (Z) will be 147 (3½*3*14). This configuration results in the greatest common divisor (GCD) of the number of stator slots (Z=147) and the number of poles (P=14) being 7. This configuration results in the lowest common multiplier (LCM) of the number of stator slots (Z=147) and the number of poles (P=14) being 294.

In another example, the number of phases (M) is 3 and the number of poles (P) is 16. In this case the number of stator slots (Z) will be 168 (3½*3*16). This configuration results in the greatest common divisor (GCD) of the number of stator slots (Z=168) and the number of poles (P=16) being 8. This configuration results in the lowest common multiplier (LCM) of the number of stator slots (Z=168) and the number of poles (P=16) being 336.

Alternatively, the slots per pole per phase (X) may be set to be exactly 3½, with the number of phases (M) being set as 5. The number of poles (P) may be set to be 12. In this case the number of stator slots (Z) will be 210 (3½*5*12). This configuration results in greatest common divisor (GCD) of the number of stator slots (Z=210) and the number of poles (P=12) being 6. This configuration results in the lowest common multiplier (LCM) of the number of stator slots (Z=210) and the number of poles (P=12) being 420.

Referring now to FIG. 6, a third optimal configuration 74 is shown for the electric machine 10, with like reference numbers referring to the same or similar components. In the third optimal configuration 74, the slots per pole per phase value (X) is set to be exactly 1½. Since the slots per pole per phase value (X) is exactly 1½, the number of stator slots 36 found in the two poles 26 (or stator slots per pole pair) may be determined by the number of phases (M) in each winding set. For example, if the number of phases (M) is 3 in each winding set, the number of stator slots 36 found in two poles 26 (i.e. stator slots 36 per pole pair) is nine [number of stator slots per pole pair=1½ (slots per pole per phase)*3 phase*2 poles per pole pair]. The embodiment illustrated in FIG. 6 shows nine stator slots 36 for the two poles 26. Additionally, the number of stator slots (Z) may be required to be at least 60.

The third optimal configuration 74 is similar to the first and second optimal configurations 70, 72 unless otherwise described. In the third optimal configuration 74, the GCD and LCM of the number of stator slots (Z) and the number of poles (P) is at least 6 and at least 72, respectively. In one example, the number of phases (M) is 3, the number of poles (P) is 14 and the total number of stator slots (Z) is 63(½*3*14). This configuration results in the GCD and LCM (of the number of stator slots and the number of poles) being 7 and 126, respectively.

In another example, the number of phases (M) is 3, the number of poles (P) is 16 and the total number of stator slots (Z) is 72 (1½*3*16). This configuration results in the GCD and LCM (of the number of stator slots and the number of poles) being 8 and 144, respectively. In another example, the number of phases (M) is 3, the number of poles (P) is 18 and the total number of stator slots (Z) is 81 (1½*3*18). This configuration results in the GCD and LCM (of the number of stator slots and the number of poles) being 9 and 162, respectively.

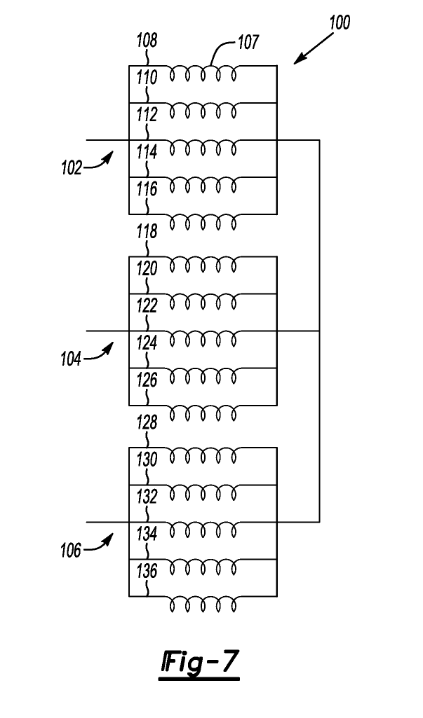

FIG. 7 is a schematic diagram of the electrical connections 100 or parallel paths per phase (n) of the stator windings 40 of FIGS. 3, 5 and 6. Referring to FIG. 7, in each optimal configuration 70, 72 and 74, the stator windings 40 may include at least five parallel paths per phase. In other words, each phase may include five parallel branches of windings. It is to be appreciated that the stator windings 40 may include any number of phases (M) and any number of parallel paths per phase (n). Referring to FIG. 7, the stator windings 40 may include first, second and third phases 102, 104, 106. The first phase 102 includes paths 108, 110, 112, 114 and 116. The second phase 104 includes paths 118, 120, 122, 124 and 126. The third phase 106 includes paths 128, 130, 132, 134 and 136. Each parallel winding branch or path 108, 110, 112, 114, 116, 118, 120, 122, 124, 126, 128, 130, 132, 134 and 136 may include at least one coil segment 107.

A fractional stator slots per pole per phase (X) configuration having a defined parameter set as outlined above (optimal configurations 70, 72, 74) allows for greater flexibility in designing an electric machine 10 with a particular torque or system voltage requirement. Arbitrarily specifying a configuration for an electric machine 10 will not produce the required torque output or meet minimum noise requirements. Only specific configurations with a particular number of slots (Z), number of phases (M), number of poles (P), number of winding sets (W) etc. will produce the desired functionality. These specific configurations cannot readily be determined by inspection. If an arrangement is not selected correctly, the design will either perform poorly or will not meet the functional requirements. Because of the large number of possible combinations, the optimal configuration is neither easily determined nor obvious.

For example, if the stator slots per pole per phase (X) is chosen to be 2¼ or 1¾ or 1⅕, cross jumpers are required in order to complete the connections between the bar conductors 42. As previously shown in FIG. 4, the stator assembly 24 may include jumpers 66 for electrically engaging the ends of at least two bar conductors 42. A cross jumper is a jumper which has two ends that must cross over other jumpers in order to connect. The optimal configurations 70, 72, 74 (X=2½, 3½, 1½ respectively) do not require cross jumpers in order to complete the connections between the bar conductors 42. Stated differently, optimal configurations 70, 72, 74 (X=2½, 3½, 1½ respectively) provide a repeatable winding configuration over one pole pair (the two poles 26 shown in FIGS. 2, 5 and 6). Additionally, if the stator slots per pole per phase (X) is chosen to be 2¼ or 1¾ or 1⅕, a greater number of total jumpers 66 are required in order to complete the connections between the bar conductors 42.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. An electric machine comprising:
a stator core defining a number of stator slots (Z) extending along a longitudinal axis and angularly spaced about the longitudinal axis;
a rotor assembly positioned at least partially within the stator core, the rotor assembly including at least one permanent magnet and defining a number of poles (P);
wherein the number of poles (P) is greater than or equal to 12;
a plurality of stator windings positioned in each of the number of stator slots (Z) and defining a number of phases (M);
wherein the machine defines a non-integer slots per pole per phase value (X), the slots per pole per phase value (X) being expressed as a mixed fraction in the form of A(^{B}/_{C}) such that A, B and C are integers;
wherein the value of C is not equal to the number of phases (M); and
wherein a greatest common divisor (GCD) of the number of stator slots (Z) and the number of poles (P) is at least 6, the GCD being defined as a largest positive integer that divides the number of stator slots (Z) and the number of poles (P) without a remainder.

2. The machine of claim 1, wherein the slots per pole per phase value (X) is exactly 2½.

3. The machine of claim 2, wherein the number of phases (M) is 3, the number of poles (P) is 12 and the number of stator slots (Z) is 90.

4. The machine of claim 2, wherein the number of phases (M) is 3, the number of poles (P) is 14 and the number of stator slots (Z) is 105.

5. The machine of claim 2, wherein the number of phases (M) is 3, the number of poles (P) is 16 and the number of stator slots (Z) is 120.

6. The machine of claim 2, wherein the number of phases (M) is 3, the number of poles (P) is 18 and the number of stator slots (Z) is 135.

7. The machine of claim 2, wherein the plurality of stator windings each include at least five parallel paths per phase.

8. The machine of claim 2, wherein a lowest common multiplier (LCM) of the number of stator slots (Z) and the number of poles (P) is at least 72, the LCM being defined as a smallest positive integer that is divisible by both the number of stator slots (Z) and the number of poles (P).

9. The machine of claim 1, wherein the slots per pole per phase value (X) is exactly 3½.

10. The machine of claim 9, wherein the number of phases (M) is 3, the number of poles (P) is 12 and the number of stator slots (Z) is 126.

11. The machine of claim 9, wherein the number of phases (M) is 3, the number of poles (P) is 14 and the number of stator slots (Z) is 147.

12. The machine of claim 9, wherein the number of phases (M) is 3, the number of poles (P) is 16 and the number of stator slots (Z) is 168.

13. The machine of claim 9, wherein the plurality of stator windings each include at least five parallel paths per phase.

14. The machine of claim 9, wherein a lowest common multiplier (LCM) of the number of stator slots (Z) and the number of poles (P) is at least 72, the LCM being defined as a smallest positive integer that is divisible by both the number of stator slots (Z) and the number of poles (P).

15. The machine of claim 1, wherein the slots per pole per phase value (X) is exactly 1½.

16. The machine of claim 15, wherein the number of phases (M) is 3, the number of poles (P) is 14 and the number of stator slots (Z) is 63.

17. The machine of claim 15, wherein the number of phases (M) is 3, the number of poles (P) is 16 and the number of stator slots (Z) is 72.

18. The machine of claim 15, wherein the number of phases (M) is 3, the number of poles (P) is 18 and the number of stator slots (Z) is 81.

19. An electric machine comprising:
a stator core defining a number of stator slots (Z) extending along a longitudinal axis and angularly spaced about the longitudinal axis;
a rotor assembly positioned at least partially within the stator core, the rotor assembly including at least one permanent magnet and defining a number of poles (P);
wherein the number of poles (P) is greater than or equal to 12;
a plurality of stator windings positioned in each of the number of stator slots (Z) and defining a number of phases (M);
wherein the machine defines a non-integer slots per pole per phase value (X), the slots per pole per phase value (X) being expressed as a mixed fraction in the form of A(^{B}/_{C}) such that A, B and C are integers;
wherein the value of C is not equal to the number of phases (M);
wherein a greatest common divisor (GCD) of the number of stator slots (Z) and the number of poles (P) is at least 6, the GCD being defined as a largest positive integer that divides the number of stator slots (Z) and the number of poles (P) without a remainder;
wherein a lowest common multiplier (LCM) of the number of stator slots (Z) and the number of poles (P) is at least 72, the LCM being defined as a smallest positive integer that is divisible by both the number of stator slots (Z) and the number of poles (P);
wherein the slots per pole per phase value (X) is exactly 1½;
wherein the number of stator slots (Z) is at least 60; and
wherein the plurality of stator windings each include at least five parallel paths per phase.
